(19) United States
(12) Patent Application Publication
(10) Pub. No.: US 2005/0258643 A1
(43) Pub. Date: Nov. 24, 2005

(54) Rotary coupling for air delivery devices

(76) Inventors: Daniel J. Vanderpyl, Yorba Linda, CA (US); Terence M. Riley, Fullerton, CA (US); Jeffrey G. Johnson, Alger, MI (US)

Correspondence Address: SHELDON & MAK, INC, 225 SOUTH LAKE AVENUE, 9TH FLOOR, PASADENA, CA, 91101, US

(21) Appl. No.: 11/189,138

(22) Filed: Jul. 25, 2005

Related U.S. Application Data
(63) Continuation-in-part of application No. 09/970,568, filed on Oct. 3, 2001.

(51) Int. Cl. F01C 1/00

(52) U.S. Cl. 285/272

(57) ABSTRACT

A rotary coupling for an air delivery system, the coupling having a bearing centrally disposed in the air passage of the coupling to permit rotation of an air delivery device relative to an air inlet duct.

The present application is a continuation-in-part of U.S. patent application Ser. No. 09/970,568, filed Oct. 3, 2001, entitled “Rotatable Air Knife,” the entire disclosure of which is hereby incorporated by reference.

### BACKGROUND

Conventional air knives and air distribution manifolds are often formed as elongated structures that extend alongside or transverse to a conveyor belt or conveyor chain carrying articles to be dried or blown clean. Air knives are extensively used for drying a wide variety of articles of manufacture, such as plastic soft drink bottles prior to labeling, printed electronic circuit boards, food packaging, and many other products. Conventional pressure air delivery devices in the form of air knives and air nozzles have been used in a wide variety of industrial and commercial processes to remove or control the amount of liquid remaining on the surfaces of products after washing, rinsing, cooling, coating, or lubricating fluids have been applied. The same air delivery devices have also been used to blow dust and debris from products as well as to accelerate the heating or cooling of products. Applications for such air delivery devices include printed circuit board assembly, electroplating, food production and packaging, car and truck washing, and the manufacture of machine parts, fabricated metals, textiles, and plastic trays and totes.

Conventional air knives and air distribution manifolds are usually mounted in a fixed orientation relative to a conveyor system past which articles to be dried or cleaned are carried. One disadvantage of conventional systems of this type is that the article to be dried or blown clean passes through a curtain of air being blown at it for only a very brief instant. The flow of air of a conventional system is also directed at the article to be treated from only a single direction. The configuration of the article is often such that “blind spots” are created on portions of the article facing away from the oncoming airflow which result from the fixed angle at which the airflow is directed against the product. Air velocity is much lower in these blind spots, thus reducing the drying or cleaning effect of the flowing air. As a consequence, the article is often inadequately dried or cleaned, or in order to achieve complete drying, multiple air knives, nozzles, and blowers have often been required.

Some conventional air knife systems have been designed to impart a rocking movement to the air knife duct or to otherwise vary the angle at which the air is directed toward the article. Other prior systems employ a motor to oscillate the air knife or nozzle in one plane so as to cause a lateral air blow-off across the surface of a product. However, conventional devices of this type have been largely unsatisfactory, as the effective area of coverage and the number of passes over the surface of products to be treated are limited. Such conventional systems result in slow product conveyance speeds and sometimes even extended stationary product positioning to ensure adequate air blow-off coverage of the product.

### SUMMARY

An improved rotary coupling for use with an air delivery device is disclosed herein. The rotary coupling comprises a transfer housing, a bearing housing, and at least one bearing disposed within the bearing housing for allowing rotation of the transfer housing with respect to the bearing housing. The transfer housing is attached at a proximal end to an air distribution structure, such as an air knife. At the proximal end of the transfer housing, the housing can be integrally formed with the air distribution structure or can be otherwise fixedly attached to the air distribution structure. The transfer housing includes a hollow outer portion, a central hub within the outer portion, and a cylindrical shaft extending distally from the distal end of the central hub. The central hub is secured to the outer portion of the transfer housing by one or more mechanical connectors, which can be fins, each of which preferably includes one or more openings in order to reduce turbulence when the transfer housing rotates with respect to the bearing housing.

The cylindrical bearing has a cylindrical inner surface and a cylindrical outer surface, and is retained on the cylindrical shaft of the central hub of the transfer housing. Preferably, two spaced-apart bearings are used. Such bearings can be disposed in a bearing assembly comprising a proximal bearing retained on the cylindrical shaft; a distal bearing, retained on the cylindrical shaft at a position distal to the proximal bearing, i.e. further from the transfer housing; and a spacer interposed between the proximal bearing and the distal bearing. In a preferred embodiment, the bearing assembly can further comprise a proximal bearing retainer retained on the cylindrical shaft between the proximal bearing and the spacer, a distal bearing retainer retained on the cylindrical shaft between the spacer and the distal bearing, and a disc spring retained on the cylindrical shaft between the distal bearing retainer and the distal bearing. The spacer also preferably comprises a cylindrical tube having an interior that fits around the cylindrical shaft.

The bearing housing surrounds the cylindrical bearing and is attached to an air supply duct at a distal end. The bearing housing comprises an inner housing portion comprising a cylindrical interior surface, which is adapted to cooperate with the cylindrical outer surface of the cylindrical bearing to allow rotation of the cylindrical shaft of the transfer housing with respect to the bearing housing. The bearing housing further includes a hollow outer housing portion having a proximal end and a distal end, and one or more mechanical connectors connecting the inner housing portion to the outer housing portion.

At its distal end, the bearing housing is preferably fixedly attached to the air supply duct. In order to reduce air pressure loss, the distal end of the bearing housing can include a groove adapted to retain an 0-ring, and can also be attached to the air supply duct with a clamp. In one embodiment, the distal end of the bearing housing and the air supply duct each comprise a projection for engagement by a clamp having arms for engaging the projections of the bearing housing and the air supply duct. The clamp in this case is preferably a tri-clamp.

In a preferred embodiment, the rotary coupling further includes a retainer for securing the transfer housing to the bearing housing. The retainer can be attached at a proximal end to the cylindrical shaft, and the distal end can in this case comprise a surface adapted to engage a surface of the distal end of the bearing housing, in particular a surface at a distal end of the inner housing portion of the bearing housing. One embodiment of such a retainer can comprise a retainer assembly including a retainer ring and a fastener. The retainer ring in this embodiment can have a proximal surface adjacent the distal end of the inner housing portion of the bearing housing and also have a central opening with a shoulder. The fastener has a head and a shaft, the head being wider than the shaft and having a proximal surface for engaging the shoulder of the central opening of the retainer ring. The shaft of the fastener extends through the central opening of the retainer ring into a receptacle at the distal end of the cylindrical shaft adapted to retain the fastener. In one embodiment, the fastener is a screw, and the threads of the screw engage grooves in the receptacle to secure the retainer to the receptacle of the cylindrical shaft. Preferably, the retainer is conical in configuration to reduce air turbulence.

In another embodiment, the proximal end of the hollow outer housing portion of the rotary coupling is adapted to cooperate with the distal end of the outer portion of the transfer housing so as to restrict the passage of air from the interior of the rotary coupling to the exterior of the coupling and to allow free rotation between the outer housing portion of the bearing housing and the outer portion of the transfer housing. This embodiment of the rotary coupling can comprise an annular projection at the distal end of the transfer housing and an annular groove in the proximal end of the outer housing portion of the bearing housing, where the groove cooperates with the projection to form a labyrinth which restricts the flow of air from the interior of the rotary coupling to the exterior of the coupling. Alternatively, an annular projection in the proximal end of the outer housing portion of the bearing housing can engage an annular groove at the distal end of the transfer housing to form a labyrinth which restricts the flow of air from the interior of the rotary coupling to the exterior of the coupling. A plurality of projections and grooves can be used.

### DRAWINGS

These and other features, aspects and advantages of the present invention will become better understood with regard to the following description, appended claims, and accompanying figures where:

FIG. 1 is a perspective view of an apparatus for supplying and directing air under pressure onto articles passing beneath it on a conveyor belt.

FIG. 2 is an exploded view of the air distribution enclosure and the coupling employed in the system of FIG. 1.

FIG. 3 is a side elevational view of the coupling employed in the system of FIG. 1.

FIG. 4 is a sectional elevational view taken along the lines 4-4 in FIG. 3.

FIG. 4A is an enlarged sectional detail of the region indicated at 4A in FIG. 4.

FIG. 5 is an exploded perspective view of the coupling shown in FIGS. 3 and 4.

FIG. 6 is a perspective view of an air nozzle manifold that can be used in place of the air knife shown in FIG. 1.

FIG. 7 is a perspective view of another embodiment of an air nozzle manifold that can be used in place of the air knife shown in FIG. 1.

FIG. 8 is a side elevational view of an alternative embodiment of a rotary coupling for use with an air delivery device.

FIG. 9 is an exploded perspective view of the rotary coupling of FIG. 8.

FIG. 10 is a sectional view of the rotary coupling of FIG. 8 along line 10-10.

FIG. 11 is an exploded perspective view of the rotary coupling of FIG. 8 attached to an air knife, further showing elements for attaching the rotary coupling to an air supply duct.

FIG. 12 is a perspective view of the rotary coupling of FIG. 8 attached to an air nozzle manifold.

FIG. 13 is a perspective view of the rotary coupling of FIG. 8 attached to another embodiment of an air nozzle manifold.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION

Air Delivery Device and System

The present air delivery device comprises an apparatus for directing a flow of air on passing articles of manufacture or other products in order to dry or remove dust and debris from the articles. The flow of air is preferably directed under pressure from an air distribution enclosure or structure, which can include a plurality of primary pneumatic ejection nozzles. The device, which can be an air knife or an air distribution manifold, is preferably constructed with laterally separated, opposing ends and is mounted for rotation about a longitudinal axis equidistant from its opposing ends. An outlet such as a small thrust nozzle can be located at one or both of the opposing ends of the air distribution structure and directed so as to exert a tangential, rotational force on the opposing ends of the structure, in order to rotate it about the longitudinal axis passing through its center. Such thrust nozzles can divert a small amount of the air flowing into the plenum of an air knife or air distribution manifold so that no externally powered drive system is required to rotate it.

By rotating air knives and air distribution manifolds about a central, longitudinal axis, rather than positioning them in static, fixed orientations relative to a conveyor system, each passing article is exposed to an airflow for a considerably longer period of time, thereby increasing the dwell time of the air knife over the article. A rotating air knife can also deliver air to an approaching article from continuously varying directions, which allows an article to be dried or blown off more effectively since the airflow impinges upon the article from different directions as the air knife rotates. This increase in effectiveness allows articles to be dried or have particles blown off in a shorter amount of time, thereby allowing the speed of the conveyor system to be increased.

The present air delivery device can be included in a system for delivering air to passing articles. Such a system can comprise an air distribution structure, at least one thrust nozzle, a blower, and a rotatable coupling. The air distribution structure has opposing, laterally separated ends from which air under pressure is directed at passing articles. A central inlet opening defining an axis of rotation is located midway between the opposing ends, and the blower has an inlet duct leading to the inlet opening in the air distribution structure. The rotatable coupling joins the air distribution structure to the inlet duct and permits rotation of the air distribution structure relative to the inlet duct.

The air delivery device can be, in one embodiment, an elongated air knife having a narrow air discharge slot extending between the opposing ends. Such an air knife expels air not only at its opposing ends, but also in a band that extends linearly between the opposing ends. The band of air flow is emitted through the narrow air discharge slot that is rotated over a circular area by the jets of air emitted from the thrust nozzles. These air jets rotate the air knife about the longitudinal axis and in a plane generally parallel to the direction of conveyor advancement. Alternatively, the air distribution structure can comprise a manifold having a plurality of separate primary drying or blow-off outlet nozzles. These primary nozzles can be located only at the ends of the manifold, or can be spaced along its length between the ends as well as at the ends of the manifold.

The thrust nozzles of the air delivery system can have a fixed configuration and a discharge orifice of fixed area and shape. With this configuration, the thrust for rotating the air knife is determined solely by the pressure of air within the plenum. Preferably, however, each of the thrust nozzles is provided with an adjustment mechanism, such as an infinitely variable orifice valve, to vary the force of the jets of air. These adjustment mechanisms can be manipulated so as to direct a greater or smaller portion of the air in the plenum through the thrust nozzles.

The orientation of these thrust nozzles is in a direction tangential to the axis of rotation. The air delivery device can be continuously rotated by compressed air flow to the thrust nozzles to achieve rotational speeds of from 1 to 200 rpm. The thrust nozzles on the ends of the air delivery device produce air jets that create a tangential, rotational thrust force, thereby eliminating the need for a separate, secondary drive mechanism to provide rotational force.

The air delivery system also includes a blower supplying air under pressure from an air supply duct to the air distribution structure. The present system supplies air from a blower at, e.g., an air pressure of up to ten pounds per square inch. The blower air passes through both rotating and stationary components of the coupling assembly. The system allows the same blower air pressure supplied for the primary object of drying and blow-off to be used to also rotate an air delivery device.

While a variety of different kinds of couplings can be employed with the present air delivery devices, the coupling system that joins the air distribution structure to the air supply duct is preferably a low friction device, i.e., it should provide very low air pressure loss and low rotational resistance. The coupling is interposed between the inlet opening of the air distribution structure and the air supply duct and joins the air distribution structure to the air supply duct. The coupling permits rotation of the air distribution structure relative to the air supply duct about a longitudinal axis of rotation centered at the inlet opening which is preferably perpendicular to the air distribution structure. A bearing ring can be interposed between the stationary and rotatable components of the coupling in order to reduce friction. It is also preferable to minimize any escape of air through the coupling components, which can be accomplished by constructing the stationary and rotatable components of the coupling to define a tortuous path of resistance to the flow of air radially outward from the coupling with respect to the longitudinal axis of rotation.

In this connection, the stationary and rotatable components of the coupling can respectively include stationary and rotatable tubular structures that define radially projecting flanges at their extremities. The flanges reside in mutually facing relationship, and the rotatable tubular member of the coupling is in coaxial alignment with the stationary tubular member of the coupling. One or a plurality of annular grooves can be defined in one of the flanges while one or a plurality of raised rings can be defined in the other flange. The rings fit into the grooves to permit rotation of the rotatable tube relative to the stationary tube but the nonplanar configuration of the flanges provides the necessary tortuous path of resistance to radial airflow out through the walls of the coupling.

Air Knife

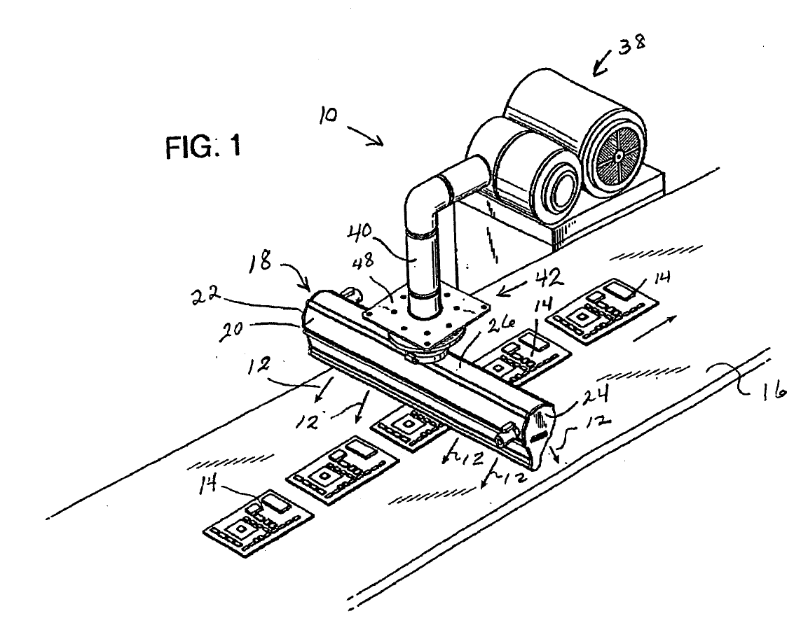

FIG. 1 illustrates an embodiment of the present system, an air knife assembly 10 which is used for directing a flow of air, indicated by the directional arrows 12, at passing articles 14. In the illustration shown, the articles 14 are printed circuit boards which are carried on a conveyor belt 16 beneath the air knife 18.

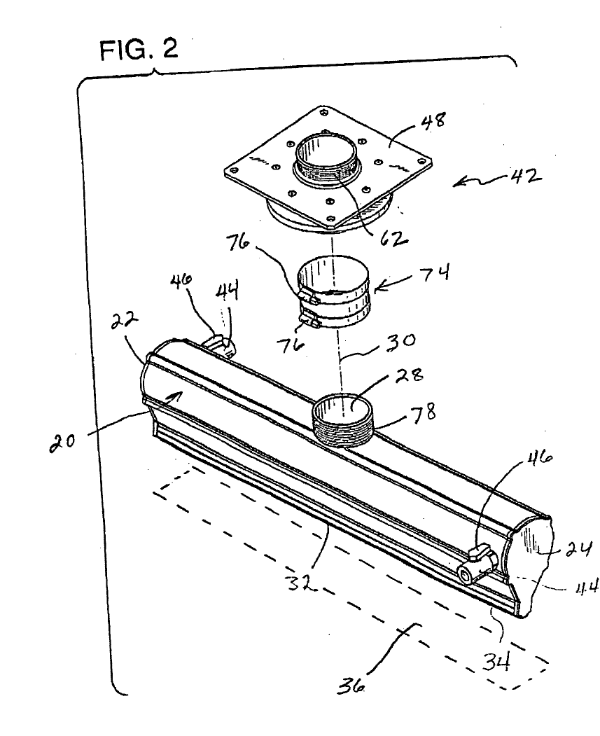

The air knife 18 is comprised of a hollow, elongated air distribution enclosure 20. The enclosure 20 is a tubular structure having opposing closed ends 22 and 24 with an inlet side 26 having a longitudinally aligned inlet opening 28 therein. The longitudinally aligned opening 28 is equidistant from the opposing ends 22 and 24 and is a circular opening centered upon a longitudinal axis 30. The air distribution enclosure 20 also has an outlet side 32 having a narrow, elongated slot 34 defined therein. The air distribution enclosure 20 emits a flow of air through the outlet slot 34 along an elongated linear band indicated in phantom at 36 in FIG. 2.

The air knife assembly 10 is also comprised of a blower 38 which includes an air supply duct 40 that supplies air under pressure to the elongated air distribution enclosure 20. One suitable blower that can be utilized as the blower 38 is the Sonic 70 centrifugal blower manufactured and sold by Sonic Air Systems, located at 4111 North Palm Street, Fullerton, Calif. 92835.

The air knife assembly 10 further includes a coupling 42 interposed between the inlet opening 28 of the elongated air distribution enclosure 20 and the air supply duct 40. The coupling 42 joins the elongated air distribution enclosure 20 to the supply duct 40. The coupling 42 is constructed to permit rotation of the elongated air distribution enclosure 20 relative to the supply duct 40 about the longitudinal axis of rotation 30 which is oriented perpendicular to the alignment of the elongated air distribution enclosure 20.

The air knife assembly 10 also includes laterally directed thrust nozzles 44 that are located on both of the opposing ends 22 and 24 of the elongated air distribution enclosure 20. The thrust nozzles 44 are oriented to emit tangential jets of air at a radially spaced distance from the longitudinal axis 30 to thereby rotate the elongated air distribution enclosure 20 about the longitudinal axis 30 relative to the supply duct 40. The air jet thrust nozzles 44 are provided with adjustable valves controlled by manually operable valve levers 46 to selectively control the thrusting force of the air jets emitted by the thrust nozzles 44.

As best illustrated with reference to FIGS. 1 and 2 of the drawings, the thrust air jet nozzles 44 rotate the air knife 18 about the longitudinal axis 30 and sweep the linear band or swath 36 in a circular path over each of the printed circuit boards 14 passing therebeneath on the conveyor 16. The rotation of the air knife 18 above the conveyor belt 16 provides an air flow 12 that does not merely impinge upon the printed circuit boards 14 in nearly a linear band 36, but rather an air flow that is directed at the articles 14 from many different directions as they are carried past the location of the air knife 18. The direction of air flow at the printed circuit boards 14 from multiple directions as the circuit boards 14 move past the air knife 18 results in far fewer blind spots and much more efficient cleaning and drying of parts moving past the air knife 18.

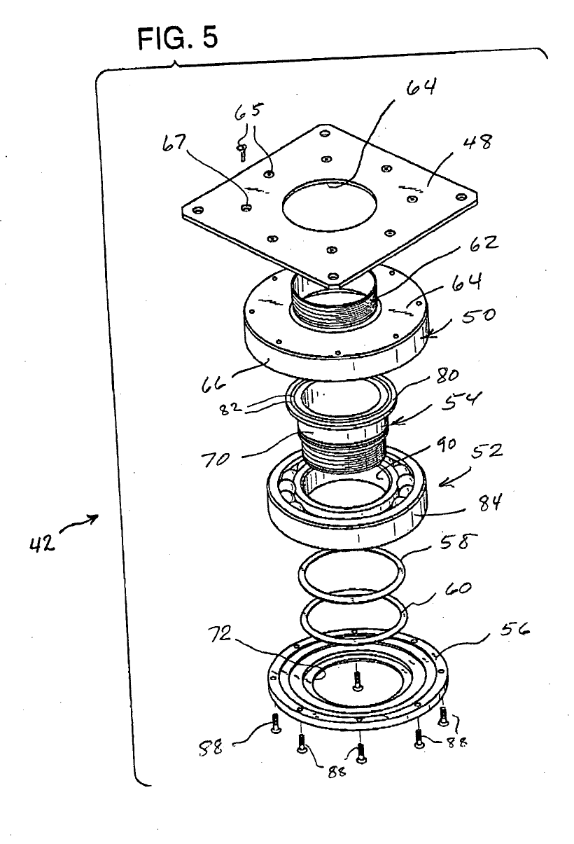

The same principle of operation can be employed if an air nozzle manifold is substituted for the air knife 18. For example, FIG. 6 illustrates an air nozzle manifold system 118 that can be substituted for the air knife 18. Like the air knife 18, the air nozzle manifold system 118 has an elongated, tubular air distribution enclosure 120, closed at both ends 122 and 124. The air nozzle manifold system 118 also has an upwardly projecting neck 78 that defines a central inlet opening 28 equidistant from the ends 122 and 124 and which can be coupled to the rubber sleeve 74 and secured thereto by a hose clamp 76 in the manner illustrated in FIG. 2. Unlike the air knife 18, the air nozzle manifold system 118 does not emit air from a single, longitudinal slot but rather from a plurality of outlet nozzles 134. At least one of the outlet nozzles 134 is located at each of the closed ends 122 and 124 of the air distribution enclosure 120 in the embodiment of FIG. 6. There are also interior outlet nozzles 134 laterally spaced and located between the end outlet nozzles 134. Thus, the air distribution enclosure 120 directs air onto passing articles 14 along a linear band, much like the band 36 shown in FIG. 2, that is rotated over a circular area by the thrust nozzles 44.

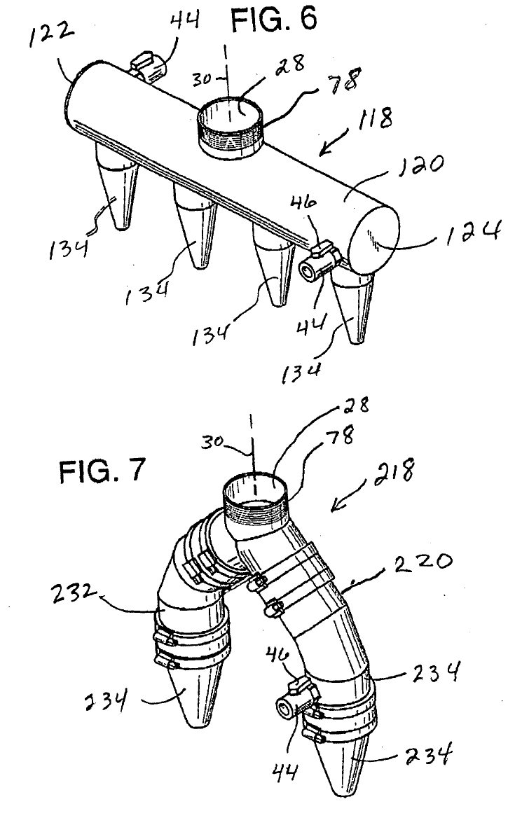

FIG. 7 illustrates another embodiment of an air nozzle manifold system 218 that employs only a pair of outlet nozzles 234 at its laterally separated ends. Like the other embodiments of the invention, the air nozzle manifold system 218 includes a central, upwardly projecting neck 78 centered on the longitudinal axis 30 midway between the opposing ends 232 and 234 of the air distribution enclosure 220.

Rotary Coupling

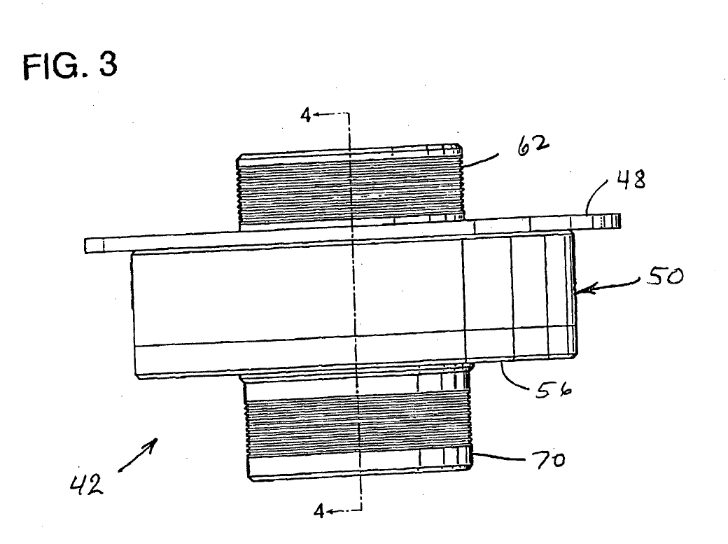

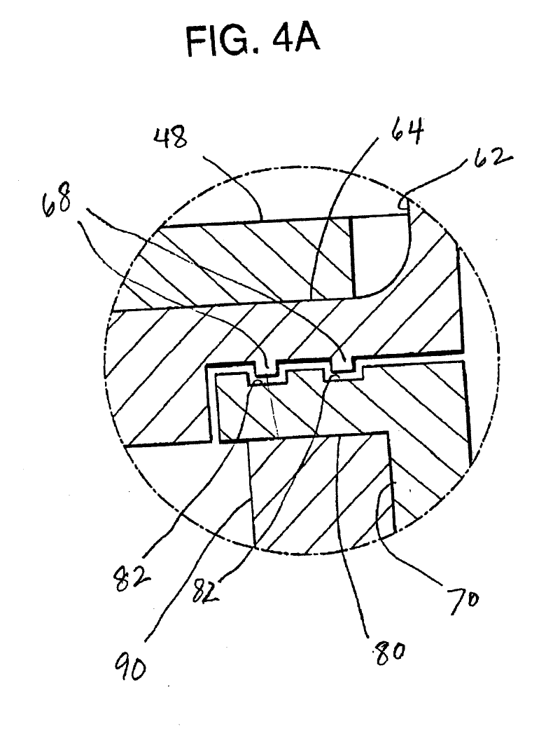

A rotary coupling 42 for use in the present system is illustrated in detail in FIGS. 3, 4, 4A and 5. The coupling 42 is comprised of a mounting plate 48, an annular, stationary coupling duct 50 which also serves as a bearing housing, an annular, greaseless ball bearing ring 52, a rotatable outlet tube 54, a bearing retainer cap 56, a spacer ring 58, and a retaining ring 60.

The stationary coupling duct 50 of the coupling 42 has a cylindrical, annular neck 62 that extends upwardly through a circular, central opening 64 in the flat, generally square mounting plate 48. Eight screws 65 pass through eight mounting holes 67 in the mounting plate 48 to attach the stationary coupling duct 50 to the mounting plate 48. The neck 62 of the stationary tube 50 is joined with an airtight seal to the inlet duct 40 in coaxial alignment with the longitudinal axis 30. The stationary coupling duct 50 also is provided with a radially projecting flange 64 that extends outwardly from the central opening of the neck 62 that is centered coaxially on the longitudinal axis 30. The coupling duct 50 also has a cylindrical annular skirt 66 that extends downwardly from the periphery of the flange 64.

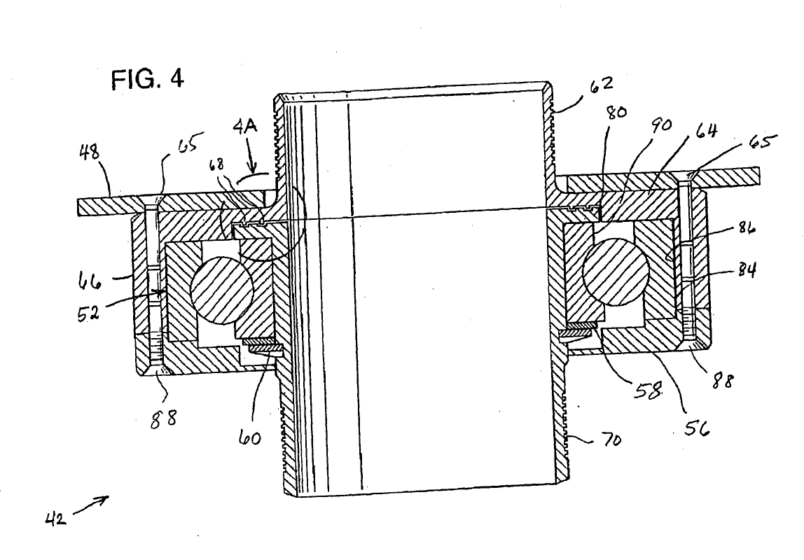

As illustrated in FIGS. 4 and 4A, an annular, concave recess is defined in the underside of the flange 64 at the inner margin thereof proximate the neck 62. In this inner marginal region the downwardly facing surface of the flange 64 is configured to define a pair of circular, annular, downwardly facing raised rings 68 which are located at spaced radial distances from the longitudinal axis 30.

The rotatable tube 54 has a downwardly depending neck 70 that extends through a central opening 72 in the retainer cap 14. The neck 70 of the rotatable tube 54 fits within a rubber hose junction sleeve 74 and is secured thereto in airtight engagement therewith by a releasable hose clamp 76. The air distribution enclosure 20 is provided with a neck 78 that projects upwardly from the inlet surface 26 to form the inlet opening 28. The neck 78 also fits into the lower end of the junction sleeve 74 and is secured thereto in airtight engagement therewith by another releasable hose clamp 76. The rotatable tube 54 is a thereby connected to the air distribution enclosure 20 in coaxial alignment with the longitudinal axis 30.

The rotatable tube 54 also has an annular flange 80 at its upper end that extends radially outwardly from the neck 70. The flange 80 is configured with a pair of circular, annular upwardly facing grooves 82 that are coaxial with respect to the longitudinal axis 30 and which reside in registration with the downwardly depending rings 68 of the flange 64 of the coupling duct 50.

The greaseless bearing ring 52 is interposed between the rotatable tube 54 and the stationary coupling duct 50. As illustrated in FIG. 4, the outer raceway 84 of the bearing ring 52 slips into the bore 86 of the skirt 66 of the coupling duct 50. The outer raceway 84 of the bearing ring 52 is entrapped and secured in place between the outer, peripheral surface of the underside of the flange 64 and the bearing retainer cap 56 by means of eight screws 88 that extend upwardly through openings in the periphery of the bearing retainer cap 56 and into tapped bores in the skirt 66 of the coupling duct 50. The inner bearing race 90 of the bearing ring 52 is held in position against the underside of the flange 80 of the rotatable tube 54 by the spacer ring 58 and the retaining ring 60.

Within the coupling 42, the radially projecting flange 64 of the stationary coupling duct 50 and the radially projecting flange 80 of the rotatable tube 54 meet in a face-to-face interface. The raised rings 68 on the underside of the flange 64 project downwardly into the annular grooves 82 in the upwardly facing surface of the flange 80. The rings 68 do not fit tightly into the grooves 82, however, as the rotatable tube 54 must be free to rotate relative to the stationary coupling duct 50. Rather, and as best illustrated in FIG. 4A, the flanges 64 and 80 are configured to define a tortuous, radial path through which air must pass to escape across the face-to-face interface between the flanges 64 and 80. As a consequence, very little pressure is lost and very little air flows radially outwardly between the stationary and rotatable parts of the coupling 42.

Alternative Rotary Coupling

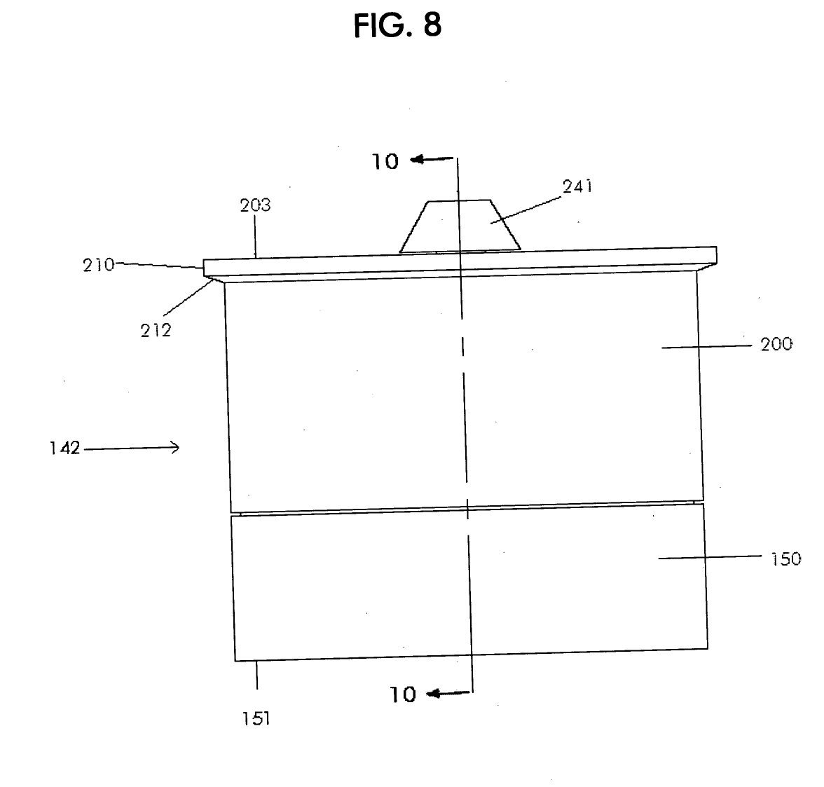

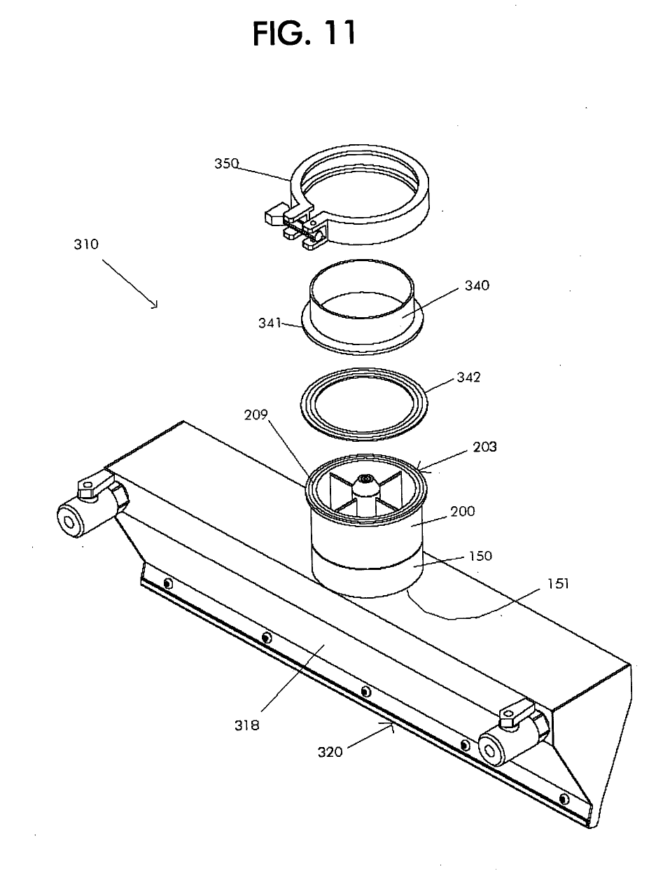

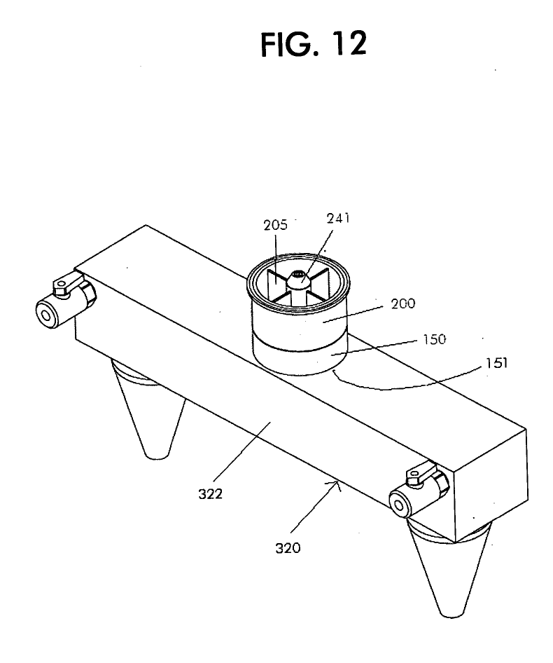

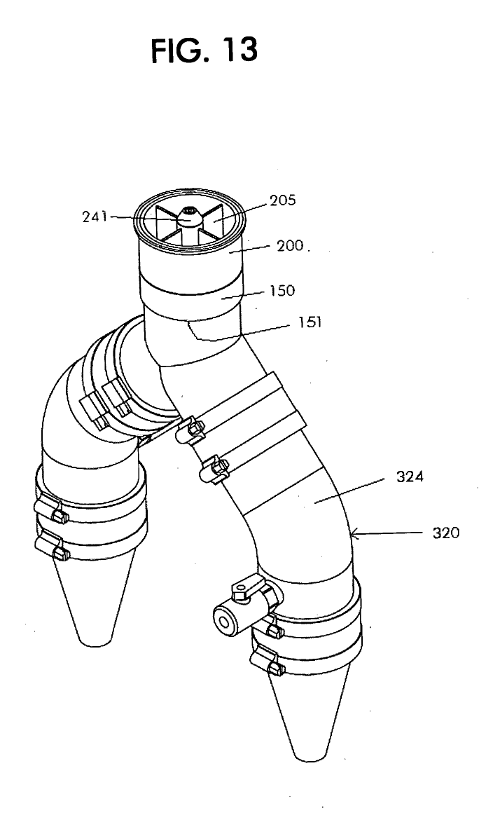

FIGS. 8-13 illustrate an alternative embodiment of a rotary coupling for use in the present system or in other applications. Like the coupling 42 shown in FIGS. 1-5, this alternative coupling 142 permits rotation of an air distribution structure 320 relative to an air supply duct 340 about an axis of rotation. In this embodiment, the air distribution structure 320 is provided with a transfer housing 150 which is fixedly attached at a proximal end 151 to the air distribution structure. For example, the air distribution structure can be an air knife 318 as shown in FIG. 11 or an air nozzle manifold such as the manifolds 322 and 324 shown in FIGS. 12 and 13, respectively.

The transfer housing 150 can be attached to the air distribution structure 320 in any way known to the art, such as by welding, chemical bonding, or mechanical attachment, or can be attached by being integrally formed with the air distribution structure 320. Such attachment should prevent substantial leakage of air from the point or points of attachment of the transfer housing 150 and the air distribution structure 320, and is preferably an air-tight attachment. The coupling 142 is preferably made from metal, in order to reduce thermal expansion if the temperature of air flowing through the coupling 142 is high, or from suitable plastic.

The transfer housing 150 comprises a hollow outer portion 152 for directing air into the air distribution structure 320. The outer portion 152 defines part of an air passage 144 in the interior of the coupling 142 through which air passes from the supply duct 340 to the air distribution structure 320, and the wall or walls of the outer portion 152 are adapted to restrict or entirely prevent the leakage of air from the air passage 144 to the exterior of the coupling 142 between the proximal end 151 and the distal end 153 of the transfer housing 150. The outer portion 152 is preferably cylindrical.

The transfer housing 150 further comprises a central hub 160 within the outer portion 152, the central hub 160 preferably having a proximal end 162 and a distal end 163. The central hub 160 is adapted to connect and secure a shaft 164 to the outer portion 152 of the transfer housing 150 by one or more mechanical connectors 166, which in the illustrated embodiment comprise fins, i.e. generally flat flanges having a length and width greater than their thickness. While the mechanical connectors 166 must be of sufficient strength and rigidity to mechanically connect the central hub 160 of the transfer housing 150 with the outer portion 152, it is preferred that the mechanical connectors 166 have a minimal thickness so as not to obstruct the passage of air through the air passage 144. In a preferred embodiment, at least one, but preferably all of the mechanical connectors 166 include one or more openings 167 in order to reduce any air turbulence generated in the coupling 142 by rotation of the transfer housing 150, and hence the mechanical connectors 166, during the operation of the air delivery system 310. The central hub 160 further provides a shoulder for retaining a bearing and/or other elements of the present rotary coupling, as described further below.

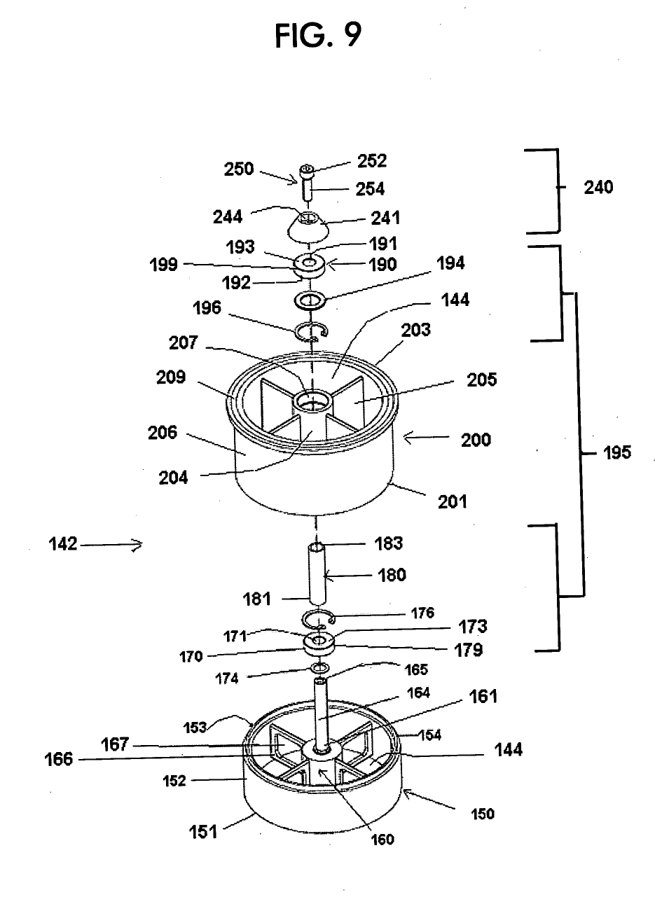

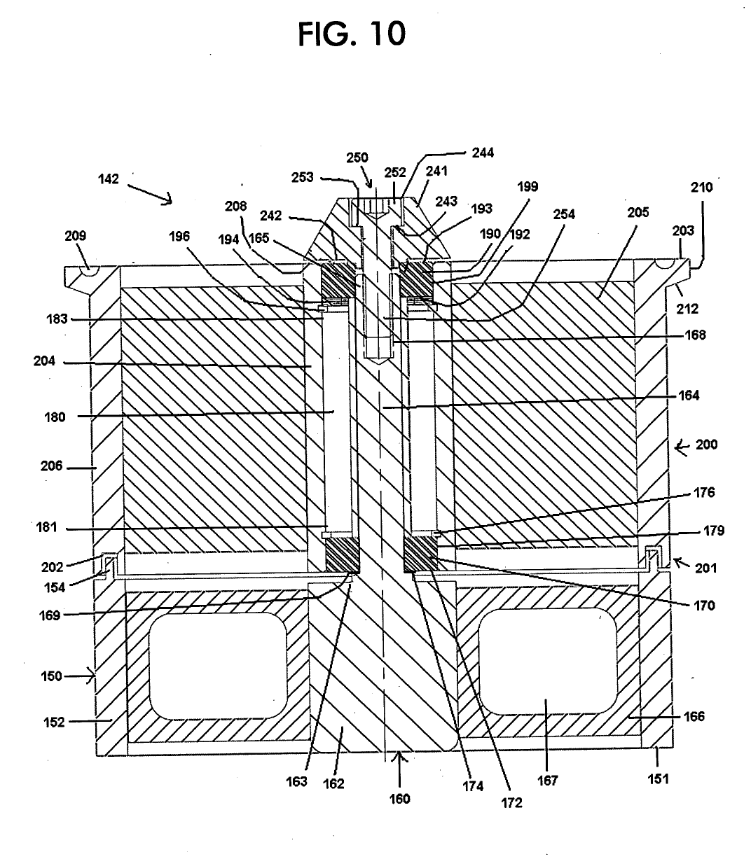

The cylindrical shaft 164 extends distally from the distal end 163 of the central hub 160 of the transfer housing 150. The shaft 164 preferably extends distally of the distal end 153 of the outer portion 152. At least a portion of the outer surface of the cylindrical shaft 164 has the general configuration of a circular cylinder in order to accommodate cylindrical bearings thereon, i.e. such that the cylindrical inner surface of such a cylindrical bearing cooperates with the cylindrical outer surface of the cylindrical shaft 164. As shown in FIGS. 9 and 10, the cylindrical shaft 164 includes a receptacle 168 at the distal end 165 of the cylindrical shaft 164, which cooperates with a fastener 250 in order to secure the transfer housing 150 to a bearing housing 200.

The cylindrical shaft 164 also cooperates with at least one cylindrical bearing. In a preferred embodiment, illustrated in FIGS. 9 and 10, the present coupling comprises two cylindrical bearings, a proximal bearing 170 and a distal bearing 190, which provide improved operation of the rotary coupling compared with the use of a single bearing when the present air delivery devices are operated with overhung loads or under unbalanced conditions. The proximal bearing 170 is retained on the cylindrical shaft 164 at a position proximal to the distal bearing 190, i.e., closer to the central hub 160, preferably at the proximal end 161 of the cylindrical shaft 164. The distal bearing 190 is retained on the cylindrical shaft 164 distally with respect to the proximal bearing 170, and preferably is retained at the distal end 165 of the cylindrical shaft 164 around at least a portion of the distal end 165 of the cylindrical shaft 164, as shown in FIG. 10. The bearings 170 and 190 each comprise a cylindrical center opening, 171 and 191 respectively, and cylindrical inner surfaces configured to allow the bearings 170 and 190 to fit over and cooperate with the cylindrical shaft 164. The bearings 170 and 190 further comprise cylindrical outer surfaces (179 and 199, respectively) and are preferably sealed and permanently greased lubed bearings.

In a preferred embodiment, a shim 174 is preferably retained on the cylindrical shaft 164 between a shoulder comprising the distal end 163 of the central hub 160 of the transfer housing 150 and the proximal face 172 of the bearing 170 in order to fix the position of the bearing 170 with respect to the central hub 160 and to transmit bearing stress. The shim 174, which is preferably a precision ground steel shim, is also preferably retained on a shoulder 169 of the distal end 163 of the central hub 160. A proximal bearing retainer 176 is also preferably retained in the cylindrical bore 204 in contact with the distal face 173 of the bearing 170.

Interposed between the proximal bearing 170 and the distal bearing 190 is a spacer 180 which is adapted to maintain the distal bearing 190 an appropriate distance from the proximal bearing 170. As shown in FIGS. 9 and 10, the spacer 180 comprises a cylindrical tube having an interior that fits around the cylindrical shaft 164. The proximal end 181 of the spacer 180 is in contact with the proximal bearing retainer 176 while the distal end 183 of the spacer 180 is in contact with a distal bearing retainer 196 associated with the distal bearing 190. In an alternative embodiment (not shown), the spacer 180 can be secured to or can be integrally formed with the cylindrical shaft 164 of the central hub 160 of the transfer housing 150. In this embodiment, the cylindrical shaft 164 is preferably provided separately from the central hub 160 and can be secured thereto, so that the proximal bearing 170 can be retained on the cylindrical shaft 164 and positioned between the central hub 160 and the spacer 180.

In embodiments in which a single bearing is used, spacers similar to the spacer 180 can be used to maintain the bearing between the shoulder 169 of the distal end 163 of the central hub 160 and a proximal surface 242 of a retainer ring 241 (described below). Such a single bearing is preferably centrally placed, in which case two spacers can be used, i.e. one between the bearing and the shoulder 169 and one between the bearing and the proximal surface 242 of the retainer ring 241. Alternatively, a longer bearing can be used without such spacers.

A proximal face 192 of the distal bearing 190 is preferably in contact with a disc spring or thrust bearing 194, which can be a Belleville washer. The disc spring 194 is preferably retained on the cylindrical shaft 164 between the distal bearing 190 and the distal bearing retainer 196. The proximal bearing 170, the proximal bearing retainer 176, spacer 180, distal bearing retainer 196, disc spring 194, and the distal bearing 190 shall be referred to collectively as the bearing assembly 195.

The bearing or bearing assembly 195 is surrounded by a bearing housing 200 comprising a hollow outer housing portion 206, which is preferably cylindrical. The outer housing portion 206 is connected to an inner housing portion 204 by mechanical connectors 205, which in the embodiment of FIGS. 9-13 are in the form of fins. As with the mechanical connectors 166, it is preferred that the mechanical connectors 205 have a minimal thickness so as not to obstruct the passage of air through the air passage 144. Such mechanical connectors 205 can also comprise openings (not shown) if the bearing housing is adapted to rotate. The inner housing portion 204 comprises a cylindrical interior surface 207 for retaining the bearing or bearing assembly 195. The cylindrical interior surface 207 is adapted to engage and cooperate with the cylindrical outer surfaces 179 and 199 of the bearings 170 and 190 to allow rotation of the cylindrical shaft 164 of the transfer housing 150 with respect to the bearing housing 200.

The proximal end 201 of the outer housing portion 206 of the bearing housing 200 is preferably adapted to engage the distal end 153 of the outer portion 152 of the transfer housing 150 so as to restrict the flow of air from the air passage 144 to the exterior of the coupling 142 but also to allow free rotation between the outer housing portion 206 of the bearing housing 200 and the outer portion 152 of the transfer housing 150. As with the coupling 42 illustrated in FIGS. 1-5, this can be accomplished by providing a flange or projection 154 at the distal end 153 of the transfer housing 150 which cooperates with a groove. 202 in the proximal end 201 of the outer housing portion 206 of the bearing housing 200. The groove 202 surrounds and cooperates with the projection 154 to form a labyrinth which restricts the leakage of air from the air passage 144 to the exterior of the coupling 142. The labyrinth is formed when the projection 154 is inserted into the groove 202 of the bearing housing 200 and these components meet in a face-to-face interface to define a tortuous, radial path through which air must pass to escape across the face-to-face interface. It is to be understood that a plurality of projections 154 can be provided to cooperate with a like number of grooves 202, as shown in FIG. 4A with respect to coupling 42, and that projections and grooves can be included on either or both of the outer housing portion 206 of the bearing housing 200 and the outer portion 152 of the transfer housing 150. When two bearings (i.e., the proximal bearing 170 and distal bearing 190) are used in the present rotary coupling, the grooves and projections can be smaller and relatively closer together than in other embodiments because such grooves and projections are subjected to less movement relative to each other (other than rotational movement). In such an embodiment the use of a single groove and projection can provide a sufficient restriction on the flow of air through the labyrinth created by the groove and projection.

The groove 202 and projection 154 are annular. While the faces of the outer housing portion 206 of the bearing housing 200 and the outer portion 152 of the transfer housing 150 can have configurations other than the illustrated cylindrical configuration, the groove 202 and projection 154 must be annular in order to allow rotation between the bearing housing 200 and the transfer housing 150 of the coupling 142.

The distal end 203 of the bearing housing 200 is adapted to engage and be fixedly attached to the air supply duct 340 as shown in FIG. 11. Preferably, the distal end 203 of the bearing housing 200 is attached to the air supply duct 340 such that there is an air tight seal between the bearing housing 200 and the air supply duct 340. For example an O-ring 342 can be fit into a groove 209 at the distal end 203 of the bearing housing 200 and into a corresponding groove in a face of the air supply duct 340 in order to create such a seal. The distal end 203 can be reversibly attached to the air supply duct 340.

In a preferred embodiment, the distal end 203 of the bearing housing 200 comprises a projection or lip 210 which preferably has a sloped shoulder 212. In this embodiment, the air supply duct 340 likewise comprises a projection or lip 341. With this configuration, the bearing housing 200 can be secured to the air supply duct 340 with a one or more clamps 350 having arms that engage both the shoulder 212 of the bearing housing 200 and a shoulder of the projection or lip 341 of the air supply duct 340. For example, a fitting such as a tri-clamp connection (available from Alpha Lavel, Lund, Sweden) can be used. Other methods known to the art can also be used to attach these components.

If the air supply duct 340 is not otherwise secured to the air distribution structure 320, the cylindrical shaft 164 is preferably secured to the bearing housing 200, thereby securing the bearing housing 200 to the transfer housing 150. This can be accomplished through the use of a retainer, which can also advantageously retain the bearing assembly 195 within the inner housing portion 204 of the bearing housing 200. In the embodiment illustrated in FIGS. 8-13, the retainer is a retainer assembly 240 comprising retainer ring 241 and fastener 250, though the retainer assembly 240 can comprise any of a number of configurations. In the illustrated embodiment, the retainer ring 241 includes a proximal surface 242 adjacent to or in contact with an inner raceway surface 208 of the inner housing portion 204. The proximal surface 242 of the retainer ring 241 also faces a distal surface 193 of the distal bearing 190 and acts to retain the bearing assembly 195 within the inner housing portion 204. The retainer ring 241 of this embodiment further comprises a central opening 244 through which the fastener 250 fits in order to attach the retainer ring 241 to the cylindrical shaft 164. In other embodiments, the retainer ring 241 and fastener 250 can be formed as a single mechanical member, or the bearing housing 200 can be secured to the cylindrical shaft 164 in other ways known to the art. The retainer ring 241 is also preferably conical in order to reduce air turbulence.

As best shown in FIGS. 9 and 10, the fastener 250 includes a head portion 252 which is wider than a shaft portion 254 such that a proximal surface 253 of the head portion 252 engages a shoulder 243 within the central opening 244 of the retainer ring 241. The shaft 254 of the fastener 250 extends through the central opening 244 of the retainer ring 241 into the receptacle 168 at the distal end 165 of the cylindrical shaft 164. The shaft 254 of the fastener 250 can be secured to the receptacle 168 of the cylindrical shaft 164 in any of a variety of ways, including chemical bonding, welding, or mechanical attachment, such as through a screw or clip mechanism.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

1. A rotary coupling for an air delivery device, comprising:
(a) a transfer housing for attachment at a proximal end to an air distribution structure, the transfer housing comprising:
(i) a hollow outer portion;
(ii) a central hub within the outer portion, the central hub having a proximal end and a distal end;
(iii) a cylindrical shaft having a proximal end and a distal end, the cylindrical shaft extending distally from the distal end of the central hub; and
(iv) one or more first mechanical connectors for securing the central hub of the transfer housing to the outer portion of the transfer housing, each connector being attached to the outer portion and to the central hub;
(b) at least one cylindrical bearing having a cylindrical inner surface and a cylindrical outer surface, the bearing being retained on the cylindrical shaft of the central hub of the transfer housing; and
(c) a bearing housing surrounding the cylindrical bearing, the bearing housing having a proximal end and a distal end for attachment to an air supply duct, the bearing housing comprising:
(i) an inner housing portion comprising a cylindrical interior surface, the cylindrical interior surface being adapted to cooperate with the cylindrical outer surface of the cylindrical bearing to allow rotation of the transfer housing with respect to the bearing housing;
(ii) a hollow outer housing portion having a proximal end and a distal end; and
(iii) one or more second mechanical connectors connecting the inner housing portion to the outer housing portion.

2. The rotary coupling of claim 1, further comprising a retainer for securing the transfer housing to the bearing housing, the retainer having a proximal end and a distal end, wherein the retainer is attached at the proximal end to the cylindrical shaft, and wherein the distal end comprises a surface adapted to engage a surface of the distal end of the bearing housing.

3. The rotary coupling of claim 2, wherein the surface of the distal end of the bearing housing is a surface at a distal end of the inner housing portion of the bearing housing.

4. The rotary coupling of claim 3, wherein the retainer is a retainer assembly, the assembly comprising:
(i) a retainer ring having a proximal surface adjacent the distal end of the inner housing portion of the bearing housing, the retainer ring further comprising a central opening, the central opening including a shoulder therein; and
(ii) a fastener having a head and shaft, the head being wider than the shaft and having a proximal surface for engaging the shoulder of the central opening of the retainer ring, the shaft extending through the central opening of the retainer ring into a receptacle at the distal end of the cylindrical shaft, the shaft of the fastener being secured to the receptacle of the cylindrical shaft.

5. The rotary coupling of claim 2, wherein the retainer is conical in configuration.

6. The rotary coupling of claim 1, comprising a proximal bearing and a distal bearing disposed in a bearing assembly, the bearing assembly comprising:
(a) the proximal bearing, wherein the proximal bearing is retained on the cylindrical shaft;
(b) the distal bearing, wherein the distal bearing is retained on the cylindrical shaft at a position distal with respect to the proximal bearing; and
(c) a spacer interposed between the proximal bearing and the distal bearing.

7. The rotary coupling of claim 6, further comprising a proximal bearing retainer retained on the cylindrical shaft between the proximal bearing and the spacer.

8. The rotary coupling of claim 6, further comprising a distal bearing retainer retained on the cylindrical shaft between the spacer and the distal bearing.

9. The rotary coupling of claim 8, further comprising a disc spring retained on the cylindrical shaft between the distal bearing retainer and the distal bearing.

10. The rotary coupling of claim 6, wherein the spacer comprises a cylindrical tube having an interior that fits around the cylindrical shaft.

11. The rotary coupling of claim 1, wherein the one or more first mechanical connectors comprises a fin.

12. The rotary coupling of claim 1, wherein the one or more first mechanical connectors comprises one or more openings.

13. The rotary coupling of claim 1, wherein the proximal end of the hollow outer housing portion is adapted to cooperate with the distal end of the outer portion of the transfer housing so as to restrict the passage of air from the interior of the rotary coupling to the exterior of the coupling and to allow free rotation between the outer housing portion of the bearing housing and the outer portion of the transfer housing.

14. The rotary coupling of claim 13, further comprising:
an annular projection at the distal end of the transfer housing; and
an annular groove in the proximal end of the outer housing portion of the bearing housing, wherein the groove cooperates with the projection to form a labyrinth which restricts the flow of air from the interior of the rotary coupling to the exterior of the coupling.

15. The rotary coupling of claim 14, further comprising a plurality of projections and grooves.

16. The rotary coupling of claim 1, further comprising:
an annular projection in the proximal end of the outer housing portion of the bearing housing; and
an annular groove at the distal end of the transfer housing, wherein the groove cooperates with the projection to form a labyrinth which restricts the flow of air from the interior of the rotary coupling to the exterior of the coupling.

17. The rotary coupling of claim 1, wherein the distal end of the bearing housing is fixedly attached to the air supply duct.

18. The rotary coupling of claim 1, further comprising a groove at the distal end of the bearing housing adapted to retain an O-ring.

19. The rotary coupling of claim 1, wherein the air supply duct and the distal end of the bearing housing each comprise a projection for engagement by a clamp, the clamp having arms for engaging the projections of the bearing housing and the air supply duct.

20. The rotary coupling of claim 19, wherein the clamp is a tri-clamp.

21. The rotary coupling of claim 1, further comprising the air supply duct.

22. The rotary coupling of claim 1, wherein the proximal end of the transfer housing is fixedly attached to the air distribution structure.

23. The rotary coupling of claim 22, wherein the transfer housing is integrally formed with the air distribution structure.

24. The rotary coupling of claim 1, further comprising the air distribution structure, wherein the air distribution structure is an air knife.
